(19) United States
(12) Patent Application Publication
(10) Pub. No.: US 2015/0083318 A1
(43) Pub. Date: Mar. 26, 2015

(54) MULTI-SEASONAL CAMOUFLAGE PATTERN FABRICS AND COATINGS FOR HUNTING

(71) Applicants: Benjamin Robert Harvey, Belleville (CA); William Allan Chesher, Frankford (CA)

(72) Inventors: Benjamin Robert Harvey, Belleville (CA); William Allan Chesher, Frankford (CA)

(21) Appl. No.: 14/562,272

(22) Filed: Dec. 5, 2014

Related U.S. Application Data
(63) Continuation of application No. 13/317,407, filed on Oct. 18, 2011, now abandoned.
(60) Provisional application No. 61/455,346, filed on Oct. 20, 2010.

(51) Int. Cl. B41M 3/00; A41H 43/00

(52) U.S. Cl. CPC B41M 3/006; A41H 43/00
USPC 156/277

(57) ABSTRACT

A method of making fabrics and coatings in a camouflage pattern with a printed camouflage pattern ink layer covered by a temperature activated color changing ink layer or layers printed in a camouflage pattern, which matches the pattern in the underlying printed camouflage fabric ink layer. The temperature activated color changing ink layer changes color state with a change of temperature to another color state or a clear state, which reveals the color state of the underlying printed camouflage fabric layer. The temperatures at which the temperature activated color changing ink changes color state occurs at a pre-determined temperature so that the camouflage pattern reveal the color states and the characteristics of the foliage of the season to which the temperature corresponds.

### CROSS-REFERENCE TO RELATED APPLICATIONS

This application is a continuation of U.S. patent application Ser. No. 13/317,407, having the same title, and filed on Oct. 18, 2011, which claims priority to U.S. Provisional Patent Application No. 61/455,346, filed on Oct. 20, 2010.

### BACKGROUND OF THE INVENTION

1. Field of the Invention

The present invention relates to camouflage pattern printed fabrics and coatings for hunting clothing and equipment which change color with a change in temperature so that the camouflage pattern matches the season for which the temperature is typical.

2. Description of Prior Art

Printed camouflage pattern fabrics and coatings have been used in the hunting applications and environments for both clothing and equipment. The camouflage pattern is designed to conceal people, their clothing and equipment by allowing them to blend into the background environment.

Such camouflage patterns, in the hunting environment, are typically used to blend into a natural environment and are composed of leaves, trees and other vegetation with colors based on the foliage of the area in which the equipment is being used.

Printed camouflage patterns do not change color state and the color state of the camouflage pattern may only match one particular type of foliage at one particular time of day in one particular season. When seasons change, with the change of temperature comes a change in foliage, in terms of color, shape and type, leaves turn brown or other colors, shrivel in the fall, fall off trees in the winter, snow may appear, while with spring the vegetation sprouts, leaves start to appear and are in full color by the summer with the typical greens of summer.

Printed camouflage patterns do not allow for changes in the colors and characteristics of the foliage in the pattern to match the season.

Temperature activated color changing inks are well known in a variety of arts and can be produced in various types and materials. Such inks are available which exhibit a clear or no color state at certain temperature ranges allowing underlying colors to appear and disappear.

The present invention by creating and applying layers of temperature activated color changing ink in a printed pattern over an underlying ink layer of printed camouflage pattern which is then applied to fabric or coatings, allows colors to appear or disappear, depending on the temperature and the season, allows foliage to change size and shape, depending on the temperature, to match the season and also can be layered in a manner which allows the colors and pattern to match the ambient daylight, depending on the time of day and the corresponding temperature during the time of day.

The present invention by its unique layering method involving multiple layers applied to the underlying fabric or equipment, creates temperature specific colors in a camouflage pattern and therefore creates season specific camouflage pattern for hunting.

### SUMMARY OF THE INVENTION

In its preferred embodiment, the invention is a printed camouflage pattern fabric or coating that allows the camouflage pattern to change color with the change in outside temperature so that the camouflage pattern matches the colors and patterns appropriate to the season to which the temperature corresponds. The pattern matches the hunting environment allowing the hunter and the hunter's clothing and equipment to blend into the background.

In the preferred embodiment of the invention, a temperature activated color changing ink layer or layers is applied over a printed camouflage pattern ink layer which is printed on the fabric. In the case of a printed camouflage coating, the temperature activated color changing ink layer or layers are printed over the applied camouflage ink layer which are then applied as a coating over the equipment.

A variety of temperature activated color changing inks may be used which contain materials capable of changes in color state on changes in temperature and reversing the changes in color state in response to a change of temperature back to the original temperature.

The temperature activated color changing ink layer is printed or applied in a camouflage pattern over a printed camouflage ink layer and has a matching camouflage pattern to the underlying printed camouflage ink layer with the exception that the printed camouflage ink layer has different color states than the temperature activated color changing ink layer for the same portions of the camouflage pattern.

The change in temperature at the pre-determined temperature ranges causes a change in color state from the first color state to the second color state in the temperature activated color changing ink layer. This may be from a pre-determined color state to a clear state or another color state. With a change in the temperature, the camouflage pattern visible to the eye changes as the color state in the underlying printed camouflage ink layer becomes visible where the temperature activated color changing ink layer changes to a clear state allowing the previously hidden color state of the underlying printed camouflage ink layer to become visible. The temperature activated color changing ink layer may also change with such change in temperature to a different color state which may include translucent color state, which when combined or blended with the color state of the underlying printed pattern on the printed camouflage ink layer, is a color state different from the color state in the temperature activated color changing ink layer prior to the temperature change.

Additional temperature activated color changing ink layers may be added which change color state at different temperatures corresponding to the changes in different seasons so that the printed camouflage pattern fabric or coating can match the background foliage for multiple seasons. The colors and patterns revealed match the background colors and patterns of the foliage of the season to which the temperature corresponds.

### BRIEF DESCRIPTION OF THE DRAWINGS

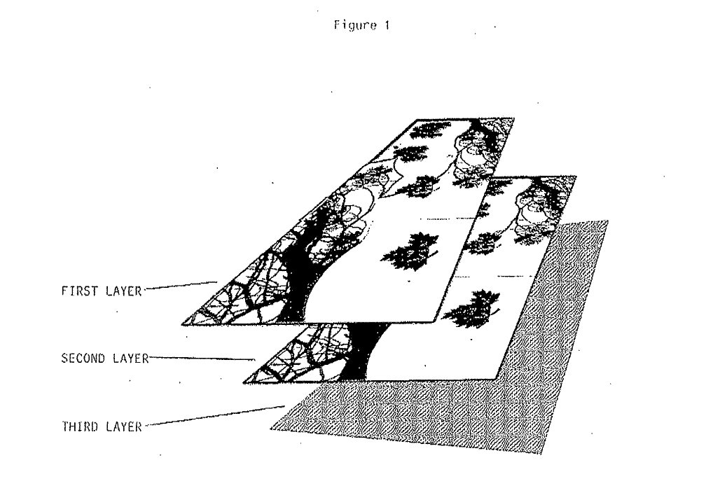

The preferred embodiment of the present invention is to be provided by way of example only with reference to the appended drawings wherein FIG. 1 is a three dimensional planar view of the printed camouflage ink layer, the temperature activated color changing ink layer and the fabric or material to which the printed camouflage ink layer and temperature activated color changing ink layer are attached in the preferred embodiment.

### DESCRIPTION OF THE PREFERRED EMBODIMENT

The temperature activated color changing inks can be purchased from any one of a number of suppliers. Temperature activated color changing inks change from one color state to another color state which may include a clear colorless state in response to a change in temperature. In preferred embodiment, this change is a reversible change so that when the temperature drops below a set temperature, the temperature activated color changing ink layer changes from one color state to another color state and when the temperature rises above the set temperature, the temperature activated color changing ink layer changes back to the original color state.

Temperature sensitive color changing inks contain materials that are temperature sensitive and change from one color state to another color state as a result of a change in temperature. Temperature activated color changing ink layers can be applied to the printed camouflage ink layer which are then applied to fabric or as a coating to equipment.

It is possible to obtain temperature activated color changing ink which changes from one color state to another color state or to a clear colorless state at set temperatures. Color state change can be from one color state to another color state. Color change can also be from one color state to a clear or colorless state depending on the temperature activated color changing ink used.

Printed camouflage ink layers applied to fabric and printed camouflage fabric for hunting can readily be obtained in the market from any one of a number of suppliers. Camouflage patterns are typically unique to the hunting equipment supplier and matches the known external environments. Camouflage patterns are typically composed of foliage such as trunks, leaves, other parts of trees or other plants with a color pattern which matches the known environment. Such printed camouflage layers and printed camouflage fabric do not change color with the seasons or with changes in temperature.

Printed camouflage patterns can be applied to fabric for hunting clothing and equipment to disguise the hunters from the hunters prey by blending into the foliage. Printed camouflage layers without the application of temperature sensitive color changing ink technology are normally in a pattern and colors representing the typical background of a single season which does not change. This requires the purchase of different camouflage patterns and colors for different seasons.

In the preferred embodiment, a temperature activated color changing ink layer is printed in the same camouflage pattern as the underlying printed camouflage ink layer but in different color states. The temperature activated color changing ink layer is overlaid over the printed camouflage layer to exactly match the pattern on the underlying printed camouflage ink layer although each layer will have different colors for different parts of the camouflage pattern. The inks in the underlying printed camouflage ink layer do not change color state with temperature.

The inks or pigments in the temperature activated color changing ink layer will change color state at set temperatures to another color state. This other color state can include a colorless or clear color state. The temperature at which the changing color occurs is pre-determined based on the typical temperature range for the seasons in the environment in which the printed camouflage fabric and the hunting clothing from which it is made and equipment to which it is applied will be used.

By application of the different inks or pigments in different parts of the pattern in the temperature activated color changing ink layer, only part of the pattern will change from one color state to another color state at the set change in temperature.

Until the change in color state occurs, the color of the temperature activated color changing ink layer, except where it is in a clear colorless state, will be the visible color for the printed camouflage pattern.

Different portions of the pattern in the temperature activated color changing ink layer may change color state at the pre-determined temperature to another color state and other portions of the pattern in the temperature activated color changing ink do not change color state at that pre-determined temperature.

Where a portion of the temperature activated color changing ink layer changes to a clear colorless state, the color on the underlying printed camouflage ink layer in respect of that portion of the underlying printed camouflage ink layer and the printed camouflage pattern is revealed.

Where the temperature activated color changing ink layer changes from one color state to another color state which is different from the original color state and also different from the color state on the corresponding pattern of the underlying printed camouflage layer and such new color state is not opaque, but is translucent, then the blending of the two color states will occur creating a new visible color state different from both layers.

The temperature activated color changing ink layer may be comprised of different colors for each portion of the camouflage pattern. Each portion of the camouflage pattern in the temperature activated color changing ink layer may change to a different color state than other portions of the temperature activated color changing ink layer.

The color states of two portions of the temperature activated color changing ink layer may be the same, but the color state on the underlying printed camouflage pattern for each of the portions may be different, resulting in different colors for different portions of the printed camouflage fabric at different temperature ranges and different seasons.

Changes in color state in the temperature activated color changing ink layer can occur at different temperatures using different pigments or inks for different portions of the pattern.

The color states which are visible in the printed camouflage fabric or coating may be contained in the temperature activated color changing ink layer or the underlying printed camouflage layer or a combination of both the temperature activated ink layer and the underlying printed camouflage layer. The color states will match the colors for the foliage typical of the season for which the type of camouflage pattern is used.

For example, if the temperature is above the temperature which is a typical summer temperature, the printed camouflage fabric can show primarily summer color states such as greens representing summer season foliage and vegetation.

When the temperature range drops to a temperature which would be typical for a fall temperature in the area in which the printed camouflage fabric or coating is being used, then a change in color state occurs in the temperature activated color changing ink layer and the colors in the resulting printed camouflage fabric will match the typical fall color states for the foliage in the area.

Another feature of the layering effect of a temperature activated color changing ink layer overlying the printed camouflage ink layer is that when the temperature activated color changing ink layer goes clear, it can show different underlying shapes of the foliage with printed camouflage ink layer, which shapes of the foliage match the shapes of the foliage for the season at which the temperature change occurs. The pattern on the underlying printed camouflage ink layer may be different from the pattern on the temperature activated color changing ink layer.

For example, if the temperature activated color changing ink layer is above the typical summer temperature for the area in which the printed camouflage fabric or coating is used, then the pattern in the temperature activated color changing ink layer would be of full leaves on trees and other plants and foliage showing summer colors for such leaves and foliage such as greens. When the temperature changes below the typical summer temperature to a temperature which would be more typical of a fall season temperature in the area in which the printed camouflage fabric or coating is used, then the leaf portion of the camouflage pattern on the temperature activated color changing ink layer would then change to a clear colorless state and the underlying pattern, which would not be a full leaf, but a shriveled leaf or a leaf of a reduced size or shape to match the season and with a different color state to match the season, such as a brown, is revealed.

Another feature of the layering effect is that multiple layers of temperature activated color changing inks can be used with different changes based on different set temperatures. For example, the first temperature activated color changing ink layer could have a pattern and colors representing the winter season. This temperature activated color changing ink layer would then change to a clear colorless state at a pre-determined temperature which matches the change of temperature on the change in season from winter to spring revealing on the second, underlying layer of temperature activated color changing ink with a pattern and colors representing the spring season. The second temperature activated color changing ink layer could change color state to a clear or colorless state at a pre-determined temperature which corresponds with the change in season from the spring season to the summer season revealing the underlying printed camouflage colors and patterns of the printed camouflage ink layer corresponding to the summer season with summer colors and foliage. This could be used in other combinations including a winter, fall, summer combination of temperature activated color changing ink layers.

The layers could also be used to change colors and patterns in the camouflage pattern to correspond to temperatures to match hunting hour changes from daylight to evening so that at temperature ranges typical of daylight during the hunting season, the camouflage pattern and colors typical for daylight would show on the camouflage pattern of the temperature activated color changing ink layer and on a drop in temperature corresponding to temperature for evening hours, the temperature activated color changing ink layer would change to a clear colorless state showing the underlying camouflage pattern ink layer and colors which would be typical for evening hours with shadows and darker colors typical of lower light conditions.

We claim:

1.-11. (canceled)

12. A hunting garment with a camouflage pattern, comprising:
a garment substrate including a fabric material;
a first layer of ink on the fabric material, the first layer of ink including a plurality of colors and depicting a pattern illustrating at least one of leaves, tree trunks, and tree branches in a first season; and
a second layer of ink overlaying and matching in shape the first layer of ink, the second layer of ink including a layer of temperature activated color changing ink configured to change between a first transparent state and a second non-transparent state, wherein the second non-transparent state depicts the pattern in a second season, and wherein the second layer of ink changes from the first transparent state to the second non-transparent state when an ambient temperature exceeds a first temperature threshold, the first temperature threshold corresponding to the second season.

13. The hunting garment of claim 12, further comprising:
a third layer of ink overlaying and matching in shape the first layer of ink, the third layer of ink including a second layer of temperature activated color changing ink, wherein the second layer of temperature activated color changing ink changes between a first transparent state and a second non-transparent state, wherein the second non-transparent state of the second layer of temperature activated color changing ink depicts the pattern in a third season, and wherein the third layer of ink changes from the first transparent state to the second non-transparent state when the ambient temperature exceeds a second temperature threshold, the second temperature threshold corresponding to the third season.

14. An article, comprising:
a material including a fabric material; and
a layer of ink on the fabric material, the layer of ink including a layer of temperature activated color changing ink, wherein the layer of temperature activated color changing ink changes between a first state and a second state based on an ambient temperature, wherein the first state displays a first plurality of colors depicting a pattern illustrating plant foliage, and the second state displays a second plurality of colors depicting the pattern.

15. The article of claim 14, wherein the first plurality of colors includes colors observed in the plant foliage in a first season, and the second plurality of colors includes colors observed in the plant foliage in a second season.

16. The article of claim 14, wherein the first plurality of colors includes colors observed in the plant foliage in a first time of day, and the second plurality of colors includes colors observed in the plant foliage in a second time of day.

17. The article of claim 14, wherein only portions of the pattern change to the second plurality of colors.

18. The article of claim 14, further comprising a second layer of ink on the fabric material which does not change color state with a change in temperature.

19. The article of claim 14, further comprising a plurality of layers of temperature activated color changing ink where each of the plurality of layers of temperature activated color changing ink change color at different pre-determined temperatures.

20. The article of claim 14, further comprising a second layer of a first printed camouflage pattern comprised of an ink which does not change color state with a change in temperature, and a third layer of a second printed camouflage pattern comprised of a temperature activated color changing ink, wherein the second printed camouflage pattern is identical to the first printed camouflage pattern.

21. An article, comprising:
a surface;
a first layer of ink on the surface, the first layer of ink including a plurality of colors and depicting a pattern illustrating at least one of leaves, tree trunks, tree branches, and plant foliage in a first season; and
a second layer of ink overlaying and matching in shape the first layer of ink, the second layer of ink including a layer of temperature activated color changing ink configured to change between a first transparent state and a second non-transparent state, wherein the second non-transparent state depicts the pattern in a second season, and wherein the second layer of ink changes from the first transparent state to the second non-transparent state when an ambient temperature exceeds a first temperature threshold, the first temperature threshold corresponding to the second season.

22. The article of claim 21, further comprising:
a third layer of ink overlaying and matching in shape the first layer of ink, the third layer of ink including a second layer of temperature activated color changing ink, wherein the second layer of temperature activated color changing ink changes between a first transparent state and a second non-transparent state, wherein the second non-transparent state of the second layer of temperature activated color changing ink depicts the pattern in a third season, and wherein the third layer of ink changes from the first transparent state to the second non-transparent state when the ambient temperature exceeds a second temperature threshold, the second temperature threshold corresponding to the third season.
